(19) United States
(12) Patent Application Publication
(10) Pub. No.: US 2024/0045973 A1
(43) Pub. Date: Feb. 8, 2024

(54) SYMBOL NARROWING-DOWN APPARATUS, PROGRAM ANALYSIS APPARATUS, SYMBOL EXTRACTION METHOD, PROGRAM ANALYSIS METHOD, AND NON-TRANSITORY COMPUTER READABLE MEDIUM

(71) Applicant: NEC Corporation, Minato-ku, Tokyo (JP)

(72) Inventors: Yusuke Shimada, Tokyo (JP); Norio Yamagaki, Tokyo (JP)

(73) Assignee: NEC Corporation, Minato-ku, Tokyo (JP)

(21) Appl. No.: 18/267,690

(22) PCT Filed: Mar. 23, 2021
(86) PCT No.: PCT/JP2021/012047

§ 371 Date: Jun. 15, 2023

(51) Int. Cl. G06F 21/57; G06F 8/75

(52) U.S. Cl. CPC G06F 21/577; G06F 8/75

(57) ABSTRACT

A symbol narrowing-down apparatus includes a symbol extraction means for extracting a plurality of predetermined symbols from codes included in a binary of a program, a first code block extraction means for extracting a code block having a specific property as a first code block to be analyzed as to whether the code block is a backdoor, a second code block extraction means for extracting, as a plurality of second code blocks, a plurality of code blocks that access the plurality of respective predetermined symbols, a symbol narrowing-down means for extracting, from the plurality of predetermined symbols, a symbol to be accessed by the second code block satisfying a condition on a control flow according to a type of the backdoor to be analyzed among the plurality of second code blocks, and a symbol output means for outputting the symbol extracted by the symbol narrowing-down means.

### TECHNICAL FIELD

The present disclosure relates to a symbol narrowing-down apparatus, a program analysis apparatus, a symbol extraction method, a program analysis method, and a non-transitory computer readable medium.

### BACKGROUND ART

In recent years, infrastructure and company systems have become complicated. Therefore, the infrastructure and the company system are generally constructed not only by devices and software of a single company but also by procuring devices and software of various companies from the outside and combining them.

However, many cases have been reported in which a backdoor is found in software (or firmware) or hardware procured from an external manufacturer. The “backdoor” referred to in the present specification can be defined as, for example, a function that is incorporated as a part of a program including a plurality of functions constituting software and is not notified to a user and is not desired by the user.

Therefore, a manufacturer who coordinates construction of an infrastructure or a company system needs to inspect whether a backdoor is included in a program constituting software procured from an external manufacturer.

For example, Non-Patent Literature 1 describes extracting a candidate for a backdoor code by scoring a code included in a binary to be inspected. Here, in Non-Patent Literature 1, a function for comparing static data is specified from the codes included in the target binary, and scoring is performed on how much a comparison result by the specified function affects the subsequent execution path, thereby extracting the candidate for the backdoor code.

### CITATION LIST

### Non Patent Literature

Non Patent Literature 1: Sam L. Thomas, Tom Chothia, and Flavio D. Garcia, “Stringer: Measuring the Importance of Static Data Comparisons to Detect Backdoors and Undocumented Functionality”, Computer Security ESORICS 2017, pp. 513-531

### SUMMARY OF INVENTION

### Technical Problem

By the way, in a case where scoring is performed on a plurality of code blocks included in a program to be analyzed, and a code block having a high score among the plurality of code blocks is extracted as a candidate for a backdoor code, or the like, presence or absence of access to a predetermined symbol in the code block to be analyzed or a child node thereof affects an increase or decrease in the score for the code block to be analyzed.

Here, there are usually very many symbols in the program. Along with this, there are many code blocks that access these predetermined symbols. However, among the symbols, some symbols do not contribute to the increase or decrease of the score depending on the type of backdoor to be analyzed. Therefore, in the analysis of the backdoor code, it is required to narrow down symbols that contribute to the increase or decrease of the score according to the type of backdoor to be analyzed.

The present disclosure has been made to solve such a problem, and an object thereof is to provide a symbol narrowing-down apparatus, a program analysis apparatus, a symbol extraction method, a program analysis method, and a non-transitory computer readable medium capable of extracting a symbol according to a type of a backdoor to be analyzed from a large number of symbols included in a program to be analyzed.

### Solution to Problem

According to a first aspect of the present disclosure, there is provided a symbol narrowing-down apparatus including: a symbol extraction means for extracting a plurality of predetermined symbols from codes included in a binary of a program; a first code block extraction means for extracting a code block having a specific property from the codes included in the binary of the program as a first code block to be analyzed as to whether the code block is a backdoor; a second code block extraction means for extracting, as a plurality of second code blocks, a plurality of code blocks that access the plurality of respective predetermined symbols from the codes included in the binary of the program; a symbol narrowing-down means for extracting, from the plurality of predetermined symbols, a symbol to be accessed by the second code block satisfying a condition on a control flow according to a type of the backdoor to be analyzed among the plurality of second code blocks; and a symbol output means for outputting the symbol extracted by the symbol narrowing-down means.

According to a second aspect of the present disclosure, there is provided a symbol extraction method executed by a symbol narrowing-down apparatus, the symbol extraction method including: a symbol extraction step of extracting a plurality of predetermined symbols from codes included in a binary of a program; a first code block extraction step of extracting a code block having a specific property from the codes included in the binary of the program as a first code block to be analyzed as to whether the code block is a backdoor; a second code block extraction step of extracting, as a plurality of second code blocks, a plurality of code blocks that access the plurality of respective predetermined symbols from the codes included in the binary of the program; a symbol narrowing-down step of extracting, from the plurality of predetermined symbols, a symbol to be accessed by the second code block satisfying a condition on a control flow according to a type of the backdoor to be analyzed among the plurality of second code blocks; and a symbol output step of outputting the symbol extracted in the symbol narrowing-down step.

According to a third aspect of the present disclosure, there is provided a non-transitory computer readable medium storing a program for causing a computer to execute: a symbol extraction process of extracting a plurality of predetermined symbols from codes included in a binary of a program; a first code block extraction process of extracting a code block having a specific property from the codes included in the binary of the program as a first code block to be analyzed as to whether the code block is a backdoor; a second code block extraction process of extracting, as a plurality of second code blocks, a plurality of code blocks that access the plurality of respective predetermined symbols from the codes included in the binary of the program; a symbol narrowing-down process of extracting, from the plurality of predetermined symbols, a symbol to be accessed by the second code block satisfying a condition on a control flow according to a type of the backdoor to be analyzed among the plurality of second code blocks; and a symbol output process of outputting the symbol extracted in the symbol narrowing-down process.

### Advantageous Effects of Invention

According to the present disclosure, it is possible to provide a symbol narrowing-down apparatus, a program analysis apparatus, a symbol extraction method, a program analysis method, and a non-transitory computer readable medium capable of extracting a symbol according to a type of a backdoor to be analyzed from a large number of symbols included in a program.

### BRIEF DESCRIPTION OF DRAWINGS

FIG. 1 is a block diagram illustrating a configuration example of a symbol narrowing-down apparatus according to a first example embodiment.

FIG. 2 is a flowchart illustrating an example of a flow of a process of the symbol narrowing-down apparatus illustrated in FIG. 1.

FIG. 3 is a block diagram illustrating a configuration example of a program analysis apparatus including the symbol narrowing-down apparatus illustrated in FIG. 1.

FIG. 4 is a flowchart illustrating an example of a flow of a process of the program analysis apparatus illustrated in FIG. 3.

FIG. 5 is a block diagram illustrating a configuration example of a symbol narrowing-down apparatus according to a second example embodiment.

FIG. 6 is a schematic diagram illustrating an example of a control flow graph of a certain program for describing the dead code block which is an example of the code block having the specific property.

FIG. 7 is a schematic diagram illustrating an example of a control flow graph of a certain program for describing a dead code block which is an example of a code block having a specific property.

FIG. 8 is a schematic diagram illustrating an example of a control flow graph of a certain program for describing the dead code block which is the example of the code block having the specific property.

FIG. 9 is a schematic diagram illustrating an example of a control flow graph of a certain program for describing another example of the code block having the specific property.

FIG. 10 is a flowchart illustrating an example of a flow of a process of the symbol narrowing-down apparatus illustrated in FIG. 5.

FIG. 11 is a schematic diagram illustrating an example of a control flow graph of a certain program for describing a symbol narrowing-down process by the symbol narrowing-down apparatus illustrated in FIG. 5.

FIG. 12 is a schematic diagram illustrating an example of a control flow graph of a certain program for describing the symbol narrowing-down process by the symbol narrowing-down apparatus illustrated in FIG. 5.

FIG. 13 is a block diagram illustrating a configuration example of a program analysis apparatus including the symbol narrowing-down apparatus illustrated in FIG. 5.

FIG. 14 is a flowchart illustrating an example of a flow of a process of the program analysis apparatus illustrated in FIG. 13.

FIG. 15 is a diagram illustrating a hardware configuration example of a program analysis apparatus according to a third example embodiment.

FIG. 16 is a block diagram illustrating a configuration example of the program analysis apparatus at a concept stage.

### EXAMPLE EMBODIMENT

Hereinafter, example embodiments will be described with reference to the drawings. In the example embodiments, the same or equivalent elements are denoted by the same reference numerals, and repeated description will be omitted.

### Preliminary Examination by Inventor

Before describing a program analysis apparatus according to a first example embodiment, contents examined in advance by the inventor will be described.

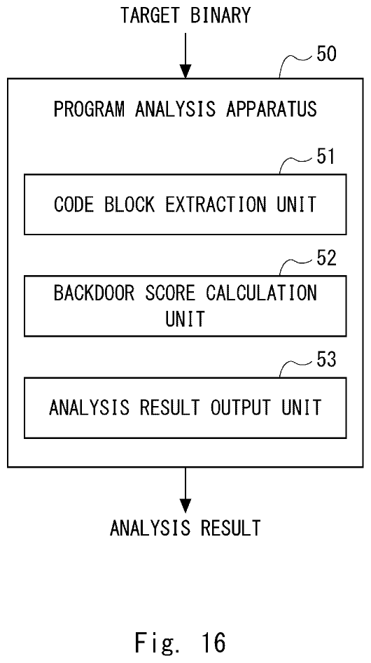

FIG. 16 is a block diagram illustrating a configuration example of the program analysis apparatus 50 at a concept stage before reaching the first example embodiment. As illustrated in FIG. 16, the program analysis apparatus includes a code block extraction unit 51, a backdoor score calculation unit 52, and an analysis result output unit 53.

The code block extraction unit 51 extracts all code blocks having specific properties from codes included in a binary (hereinafter, referred to as a target binary) of a program to be analyzed. The code block described herein indicates, for example, a code group in a functional unit or a basic block unit in a program. The code block having a specific property is, for example, a dead code block. The dead code block is a code block that cannot be reached by a normal control flow when a program is executed.

The backdoor score calculation unit 52 calculates, for each code block extracted by the code block extraction unit 51, a backdoor score that is a score indicating a possibility that the code block is a backdoor code, a score indicating the magnitude of the influence on the system when the code block is executed, or the like based on an operation content of the code block. The system described herein is, for example, a computer including an environment in which a program to be analyzed is executed.

For example, in a case where a predetermined sensitive operation exists in the code block extracted by the code block extraction unit 51, the backdoor score calculation unit 52 performs a process of adding a score set in advance for the operation to the backdoor score for the code block. The predetermined sensitive operation described herein is, for example, an operation that is considered to significantly affect a program or a system including an environment in which the program is executed when the predetermined sensitive operation is illegally executed, and is an operation determined in advance by a user (for example, a requester who requests an inspection of the program, an analyst who performs the inspection, and the like).

Here, a source code of a high-level language such as C language is mainly configured by a function and a variable having a name that can be understood by a person and whose meaning is easy to understand. When compiling the source code, a compiler generates a symbol for enabling tracking which binary code or which binary data is associated with the name of such a function and variable included in the source code. There are many symbols generated in this way in a program. The predetermined sensitive operations described above also include operations for accessing these predetermined symbols.

The analysis result output unit 53 outputs the code block extracted by the code block extraction unit 51 and the backdoor score for the code block calculated by the backdoor score calculation unit 52 as analysis results.

As described above, the program analysis apparatus 50 can present the code block that is a candidate for the backdoor code included in the program to be analyzed and the backdoor score for the code block to the analyst of the program, for example. Therefore, the analyst of the program can extract the candidate for the backdoor code from the program without comparing the code of the program to be analyzed with the specification or manually checking the code of the program.

By the way, in a case where scoring is performed on a plurality of code blocks included in a program to be analyzed, and a code block having a high score among the plurality of code blocks is extracted as a candidate for a backdoor code, or the like, presence or absence of access to a predetermined symbol in the code block to be analyzed or a child node thereof affects an increase or decrease in the score for the code block to be analyzed.

Here, as described above, there are a very large number of symbols in the program. Along with this, there are many code blocks that access these predetermined symbols.

However, even in a case where the type of backdoor to be analyzed is different, the program analysis apparatus 50 uses a large number of predetermined symbols for calculation of the score without performing narrowing. Therefore, depending on the type of backdoor to be analyzed, the program analysis apparatus may have used a symbol that does not contribute to the increase or decrease of the score for the calculation of the score.

Therefore, a symbol narrowing-down apparatus 10 according to a first example embodiment capable of extracting a symbol corresponding to the type of the backdoor to be analyzed from a large number of symbols included in the program to be analyzed has been found.

### First Example Embodiment

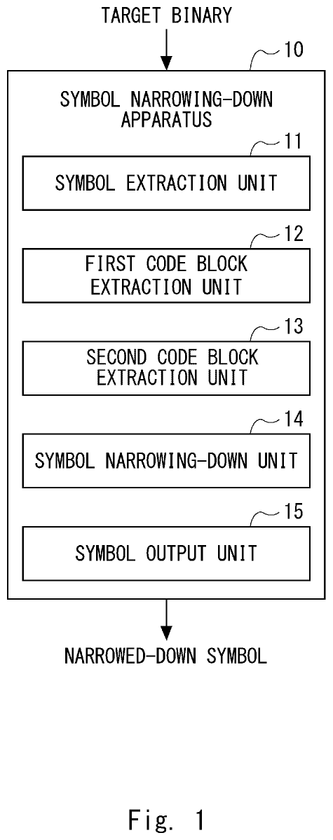

FIG. 1 is a block diagram illustrating a configuration example of the symbol narrowing-down apparatus 10 according to the first example embodiment. The symbol narrowing-down apparatus 10 can extract symbols (that is, it depends on what type of backdoor candidate is extracted) corresponding to the type of the backdoor to be analyzed from a large number of symbols included in the program to be analyzed. As a result, for example, depending on the type of backdoor to be analyzed, the program analysis apparatus can calculate the backdoor score by excluding symbols that hardly contribute to the increase or decrease of the backdoor score. Hereinafter, a specific description will be given.

As illustrated in FIG. 1, the symbol narrowing-down apparatus 10 includes a symbol extraction unit 11, a first code block extraction unit 12, a second code block extraction unit 13, a symbol narrowing-down unit 14, and a symbol output unit 15.

The symbol extraction unit 11 extracts a plurality of predetermined symbols from codes included in a binary (hereinafter, referred to as target binary) of the program to be analyzed. The plurality of predetermined symbols described herein are a plurality of symbols determined based on attribute information of at least one of the symbol type and the scope level of the symbol among all the symbols included in the target binary. The symbol type includes, for example, a data type and a function type. For example, the symbol extraction unit 11 extracts a plurality of predetermined symbols having the same symbol type and scope level from the codes included in the target binary.

The first code block extraction unit 12 extracts all code blocks having a specific property from codes included in the target binary as first code blocks to be analyzed as to whether the code blocks are backdoors. The code block described herein indicates, for example, a code group in a functional unit or a basic block unit in a program. The code block having a specific property is, for example, a dead code block. The dead code block is a code block that cannot be reached by a normal control flow when a program is executed.

The second code block extraction unit 13 extracts all code blocks that perform a predetermined sensitive operation from the codes included in the target binary. The predetermined sensitive operation described herein is, for example, an operation that is considered to significantly affect a program or a system including an environment in which the program is executed when the predetermined sensitive operation is illegally executed, and is an operation determined in advance by the user. The system is, for example, a computer including an environment in which a program to be analyzed is executed.

Here, the second code block extraction unit 13 particularly extracts a plurality of code blocks that accesses the plurality of respective predetermined symbols extracted by the symbol extraction unit 11 as a plurality of second code blocks. Note that access to a predetermined symbol is included in the predetermined sensitive operation.

First, the symbol narrowing-down unit 14 extracts a second code block that satisfies a condition on the control flow according to the type of the backdoor to be analyzed among the plurality of second code blocks extracted by the second code block extraction unit 13. Thereafter, the symbol narrowing-down unit 14 extracts a symbol to be accessed by the extracted second code block from the plurality of predetermined symbols extracted by the symbol extraction unit 11.

Examples of the type of the backdoor described herein include a backdoor of a type in which sensitive information inside a program is illegally taken outside, a backdoor of a type in which sensitive information outside the program is illegally taken inside the program, and the like. The symbol narrowing-down unit 14 extracts a second code block that satisfies such a condition on the control flow according to the type of the backdoor, and extracts a symbol to access the extracted second code block. Details of the conditions on the control flow according to the type of the backdoor will be described in detail in a second example embodiment.

The symbol output unit 15 outputs the symbols narrowed-down by the symbol narrowing-down unit 14 to the outside of the symbol narrowing-down apparatus 10. Note that the symbol output from the symbol narrowing-down apparatus 10 is used to calculate a backdoor score that is a score indicating the possibility that the first code block to be analyzed is a backdoor code or a score indicating the magnitude of the influence on the system when the first code block to be analyzed is executed.

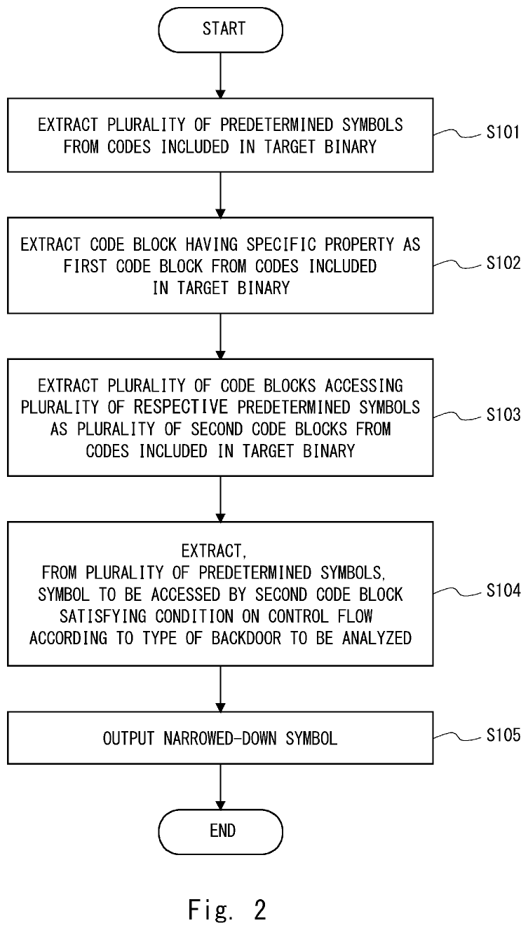

Next, an example of a flow of a process of the symbol narrowing-down apparatus 10 will be described with reference to FIG. 2.

FIG. 2 is a flowchart illustrating an example of a flow of a process of the symbol narrowing-down apparatus 10.

As illustrated in FIG. 2, first, the symbol extraction unit 11 extracts the plurality of predetermined symbols determined based on the attribute information of at least one of the symbol type and the scope level of the symbol from the codes included in the target binary (Step S101). Thereafter, the first code block extraction unit 12 extracts the code block having a specific property from the codes included in the target binary as the first code block to be analyzed as to whether the code block is the backdoor (Step S102). In addition, the second code block extraction unit 13 extracts the plurality of code blocks that accesses the plurality of respective predetermined symbols extracted by the symbol extraction unit 11 as the plurality of second code blocks (Step S103).

Thereafter, the symbol narrowing-down unit 14 extracts, from the plurality of predetermined symbols, the symbol to be accessed by the second code block that satisfies a condition on the control flow according to the type of the backdoor to be analyzed among the plurality of second code blocks (Step S104). Thereafter, the symbol output unit 15 outputs the symbol narrowed-down by the symbol narrowing-down unit 14 to the outside of the symbol narrowing-down apparatus (Step S105).

As described above, the symbol narrowing-down apparatus 10 according to the present example embodiment can extract (that is, it depends on what type of backdoor candidate is extracted) the symbol corresponding to the type of backdoor to be analyzed from a large number of symbols included in the program to be analyzed. As a result, depending on the type of the backdoor to be analyzed, a symbol that hardly contributes to the increase or decrease of the backdoor score can be excluded from the target used for calculating the backdoor score.

### Application Example of Symbol Narrowing-Down Apparatus 10

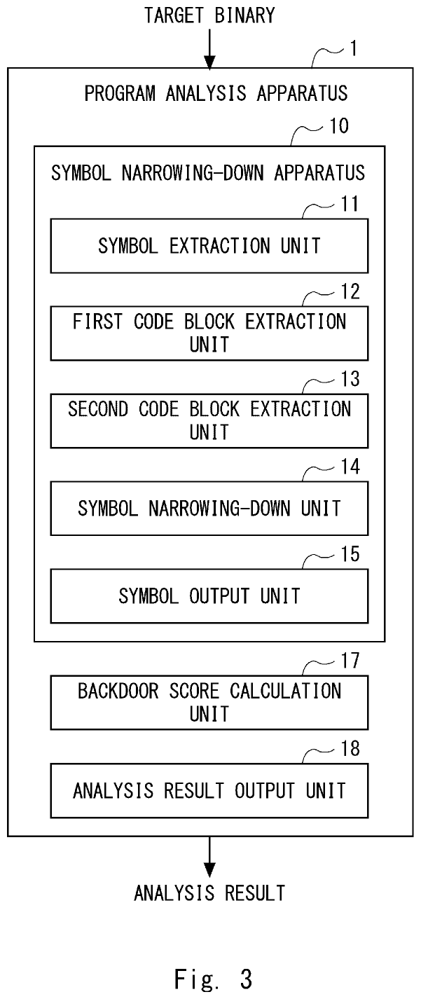

FIG. 3 is a block diagram illustrating a configuration example of the program analysis apparatus 1 on which the symbol narrowing-down apparatus 10 is mounted.

As illustrated in FIG. 3, the program analysis apparatus 1 includes a symbol narrowing-down apparatus 10, a backdoor score calculation unit 17, and an analysis result output unit 18.

The backdoor score calculation unit 17 calculates a backdoor score for each first code block extracted by the first code block extraction unit 12 based on operation content (specifically, content of the predetermined sensitive operation) of a code block that is the first code block or a child node of the first code block. Here, the backdoor score calculation unit 17 calculates the backdoor score at least based on the content of the symbol narrowed-down by the symbol narrowing-down apparatus 10, the symbol being accessed by the code block that is the first code block or a child node thereof.

The analysis result output unit 18 outputs the first code block extracted by the first code block extraction unit 12 and the backdoor score for the first code block calculated by the backdoor score calculation unit 17 as analysis results. At this time, the analysis result output unit 18 can output the analysis result in a mode in which a backdoor score for the code block is assigned to the first code block, for example.

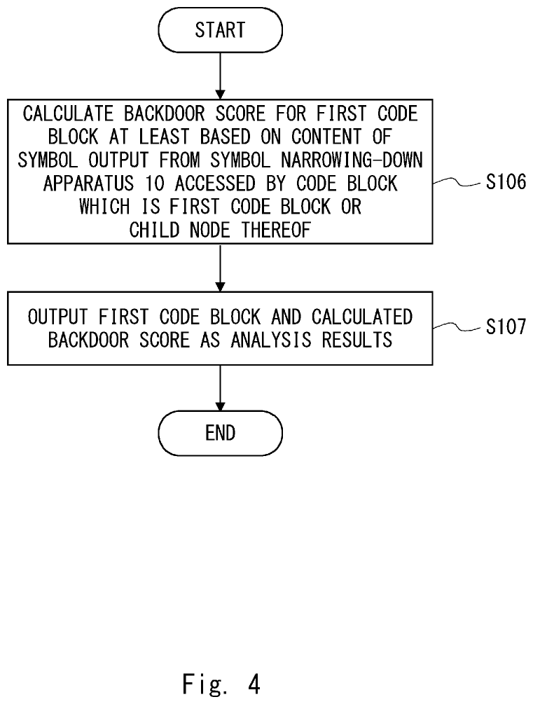

Next, an example of a flow of a process of the program analysis apparatus 1 will be described with reference to FIG. 4. FIG. 4 is a flowchart illustrating an example of the flow of the process of the program analysis apparatus 1. Note that, in FIG. 4, the symbol narrowing-down process by the symbol narrowing-down apparatus 10 is omitted.

As illustrated in FIG. 4, first, the backdoor score calculation unit 17 calculates the backdoor score for each first code block extracted by the first code block extraction unit 12 based on the operation content (specifically, content of the predetermined sensitive operation) of the code block that is the first code block or the child node of the first code block. Here, the backdoor score calculation unit 17 calculates the backdoor score at least based on the content of the symbol narrowed-down by the symbol narrowing-down apparatus 10 which is accessed by the code block which is the first code block or the child node thereof (Step S106). Thereafter, the analysis result output unit 18 outputs the first code block extracted by the first code block extraction unit 12 and the backdoor score for the first code block calculated by the backdoor score calculation unit 17 as analysis results (Step S107).

As described above, the program analysis apparatus 1 according to the present example embodiment can present the first code block that is a candidate for the backdoor code included in the program to be analyzed and the backdoor score for the first code block, for example, to an analyst of the program. As a result, the analyst of the program can extract a candidate for the backdoor code from the program without comparing the code of the program to be analyzed with the specification or manually checking the code of the program.

Furthermore, the program analysis apparatus 1 according to the present example embodiment can calculate the backdoor score by excluding the symbol that hardly contribute to the increase or decrease of the backdoor score depending on the type of the backdoor to be analyzed by using the symbol narrowing-down apparatus 10.

### Second Example Embodiment

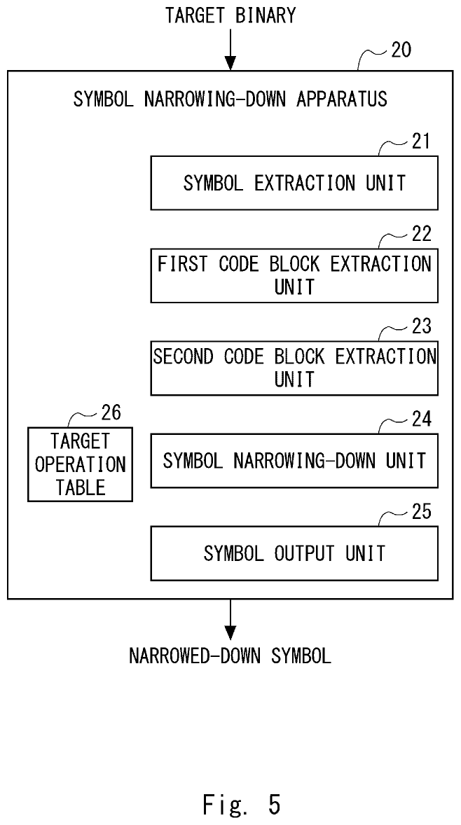

FIG. 5 is a block diagram illustrating a configuration example of the symbol narrowing-down apparatus 20 according to the second example embodiment.

As illustrated in FIG. 5, the symbol narrowing-down apparatus 20 includes a symbol extraction unit 21, a first code block extraction unit 22, a second code block extraction unit 23, a symbol narrowing-down unit 24, a symbol output unit and a target condition table 26.

The symbol extraction unit 21 extracts a plurality of predetermined symbols determined based on the attribute information of at least one of the symbol type and the scope level of the symbol from all the symbols included in the target binary.

The first code block extraction unit 22 extracts all code blocks having a specific property from codes included in the target binary as first code blocks to be analyzed as to whether the code blocks are backdoors.

More specifically, the first code block extraction unit 22 performs static analysis or the like on the target binary to create a control flow graph of the entire program. Thereafter, the first code block extraction unit 22 extracts all code blocks having specific properties as first code blocks from codes included in the target binary based on information such as the created control flow graph.

The code block having a specific property is, for example, a dead code block as described above. The dead code block is a code block that cannot be reached by a normal control flow when a program is executed.

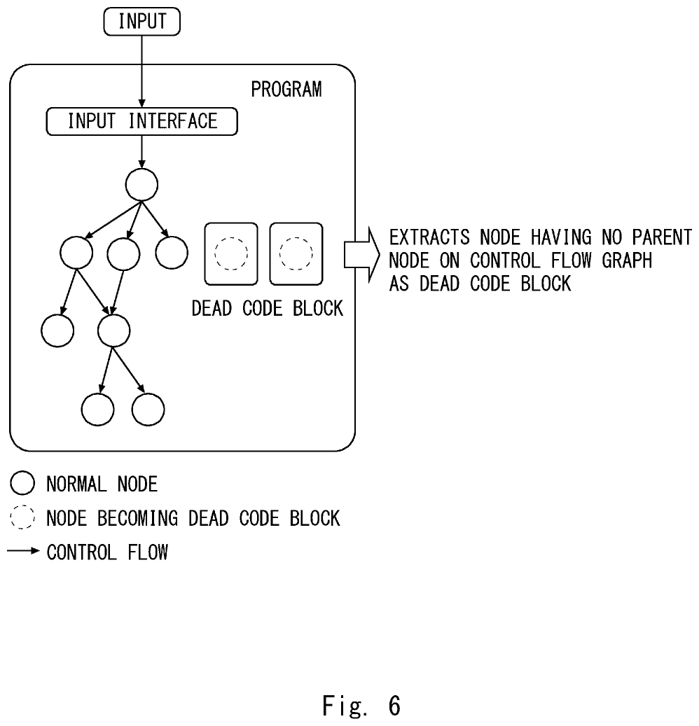

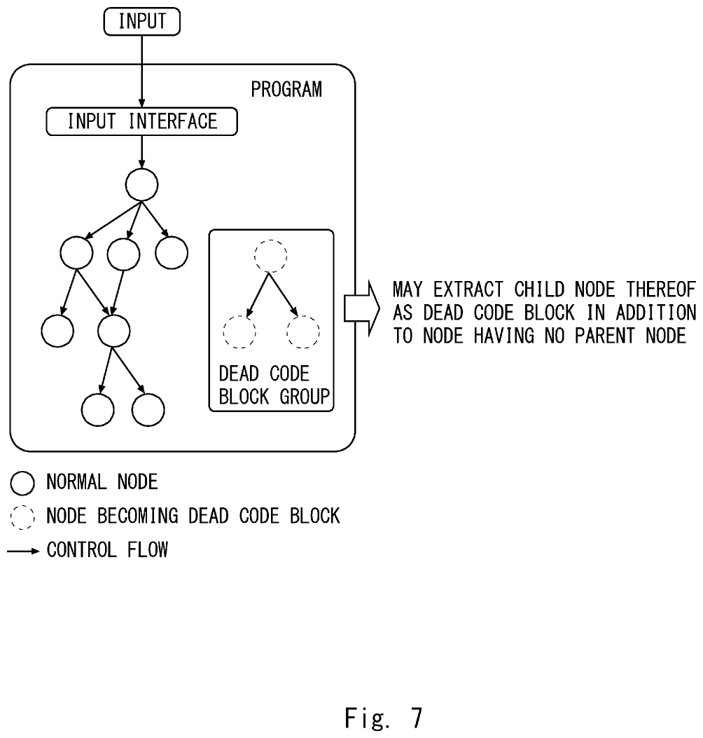

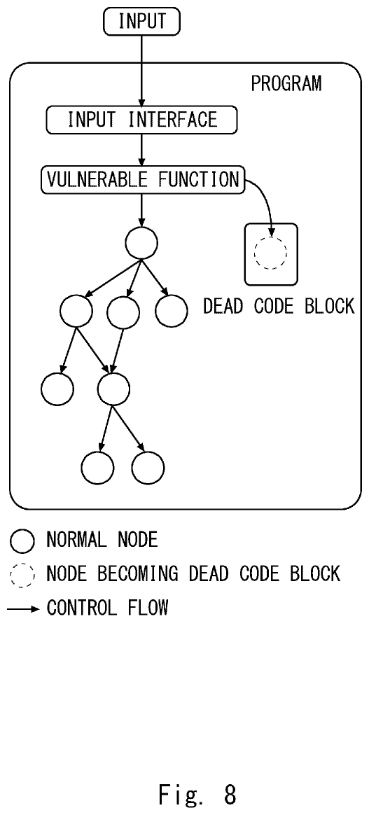

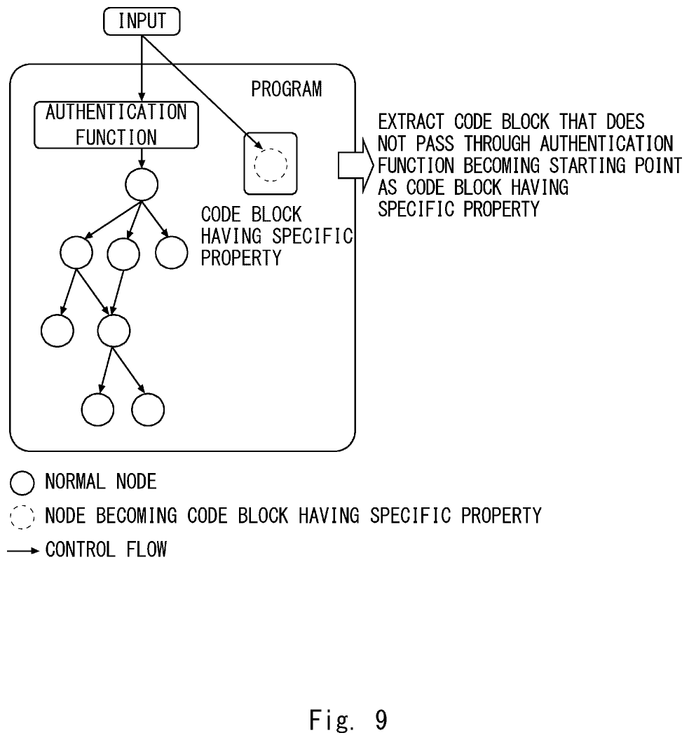

Here, an example of a method of extracting a dead code block will be described with reference to FIGS. 6 and 7. FIGS. 6 and 7 are schematic diagrams illustrating an example of a control flow graph of a certain program for describing the dead code block. In FIGS. 6 and 7, a solid circle represents a normal node, a broken circle represents a node serving as the dead code block, and an arrow represents a control flow (the same applies to FIGS. 8 and 9).

As illustrated in FIG. 6, the first code block extraction unit 22 extracts a node having no parent node on the control flow graph as the dead code block (that is, the first code block). In addition, as illustrated in FIG. 7, the first code block extraction unit 22 may extract a child node thereof as a dead code block (that is, the first code block) in addition to a node having no parent node on the control flow graph.

The dead code block described above is not executed as long as a normal input value to the program is given. However, as illustrated in FIG. 8, when there is a vulnerability in the program, the dead code block may be called and executed by the vulnerable function under a specific condition such as giving a special input value.

Note that the code block having a specific property is not limited to the dead code block described above. For example, a code block that does not pass through a predetermined function, specifically, an authentication function, a parser function, or the like, which is a starting point that is always passed through in normal execution of a program, may be the code block having the specific property. In the example of FIG. 9, the authentication function as a starting point exists on the control flow. In this case, the first code block extraction unit 22 may extract a code block that does not pass through the authentication function as a code block having a specific property.

The second code block extraction unit 23 extracts all code blocks that perform a predetermined sensitive operation from the codes included in the target binary.

As described above, the predetermined sensitive operation is, for example, an operation that is considered to significantly affect the program or the system including the environment in which the program is executed when the predetermined sensitive operation is illegally executed, and is an operation determined in advance by a user (for example, a requester who requests an inspection of the program, an analyst who performs the inspection, and the like.).

For example, the predetermined sensitive operation is an operation of calling a predetermined function or an operation of accessing a predetermined symbol (including an operation of accessing a predetermined variable and an operation of executing a predetermined command) determined in advance by the user. Examples of the operation of calling the predetermined function include an operation of calling at least one of a system call, a predetermined library function, and a predetermined application programming interface (API). Examples of the operation of accessing a predetermined symbol include an operation of accessing a global variable of the program. These predetermined sensitive operations are stored in a target operation table (not illustrated) or the like in advance by the user together with scores corresponding thereto.

Here, the second code block extraction unit 23 particularly extracts the plurality of code blocks that accesses the plurality of respective predetermined symbols extracted by the symbol extraction unit 21 as the plurality of second code blocks.

The symbol narrowing-down unit 24 first specifies the second code block that satisfies a condition on the control flow according to the type of the backdoor to be analyzed among the plurality of second code blocks extracted by the second code block extraction unit 23. Thereafter, the symbol narrowing-down unit 24 extracts the symbol to be accessed by the specified second code block from the plurality of predetermined symbols extracted by the symbol extraction unit 21.

As described above, examples of the type of the backdoor described herein include a backdoor of a type in which the sensitive information inside a program is illegally taken outside, a backdoor of a type in which the sensitive information outside the program is illegally taken inside the program, and the like. The symbol narrowing-down unit 24 specifies the second code block that satisfies the condition on the control flow according to the type of the backdoor, and then extracts the symbol to access the specified second code block.

For example, in a case where it is desired to detect the backdoor code of the type in which the sensitive information inside the program is illegally taken out to the outside, the symbol narrowing-down unit 24 first specifies the second code block which is the first code block or a child node thereof and a second code block (in other words, any one of the plurality of code blocks constituting the normal control flow) traced from a normal control flow among the plurality of second code blocks extracted by the second code block extraction unit 23. Thereafter, the symbol narrowing-down unit 24 extracts a symbol accessed from both the second code block that is the first code block or a child node thereof and the second code block traced from the normal control flow among the plurality of predetermined symbols extracted by the symbol extraction unit 21. This also means that a symbol that is not accessed by the second code block traced from the normal control flow, that is, a symbol that is not used during normal execution is excluded from the extraction target.

In addition, for example, in a case where it is desired to detect the backdoor code of the type in which the sensitive information outside the program is illegally taken into the program, the symbol narrowing-down unit 24 first specifies a second code block that is the first code block or the child node thereof and accesses an external resource (outside the program) among the plurality of second code blocks extracted by the second code block extraction unit 23. Thereafter, the symbol narrowing-down unit 24 extracts a symbol to be accessed by the specified second code block from the plurality of predetermined symbols extracted by the symbol extraction unit 21.

The target condition table 26 stores conditions corresponding to the type of backdoor to be analyzed as described above.

The symbol output unit 25 outputs the symbol narrowed-down by the symbol narrowing-down unit 24 to the outside of the symbol narrowing-down apparatus 20. Note that the symbol output from the symbol narrowing-down apparatus 20 is used to calculate the backdoor score that is the score indicating the possibility that the first code block to be analyzed is the backdoor code or the score indicating the magnitude of the influence on the system when the first code block to be analyzed is executed.

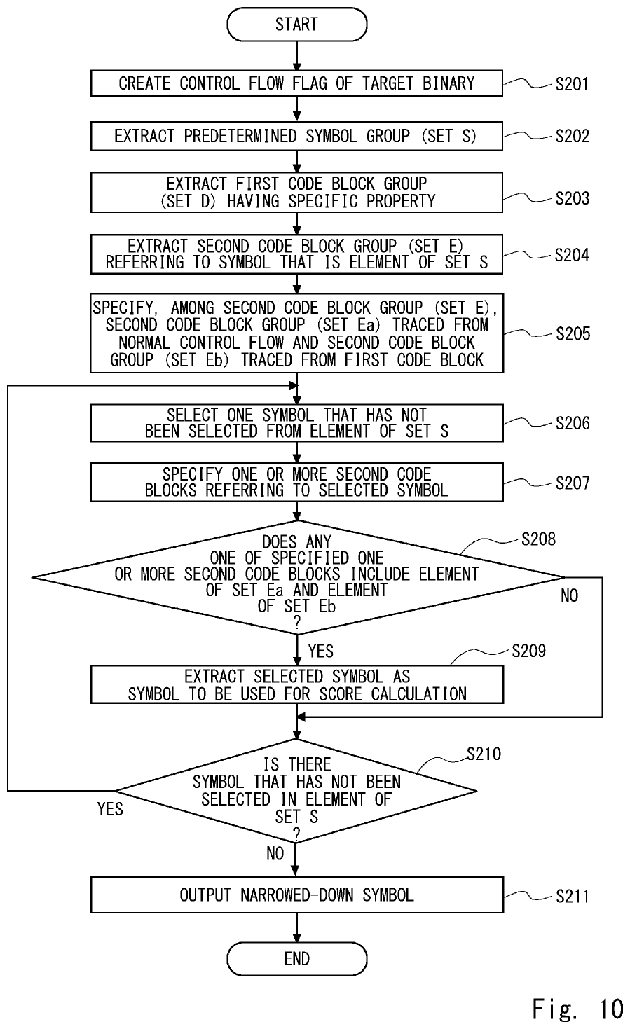

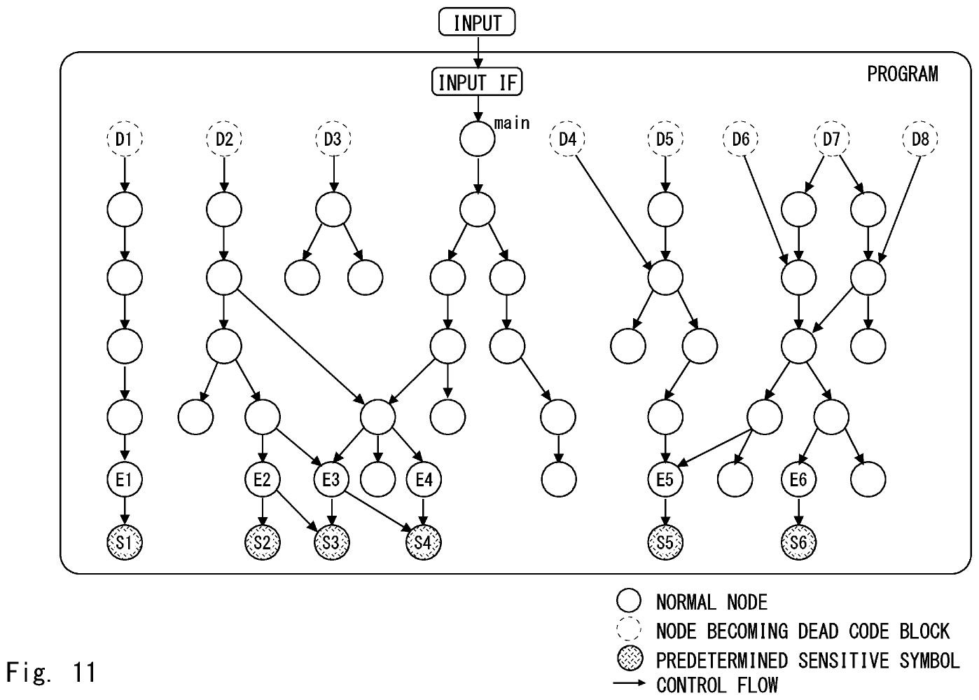

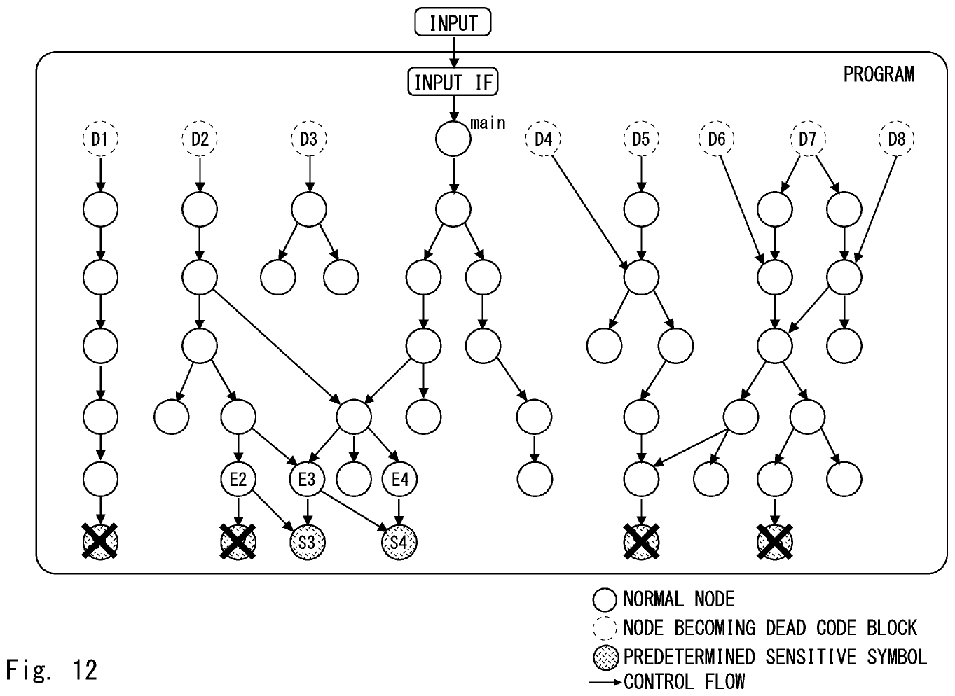

Next, an example of a flow of a process of the symbol narrowing-down apparatus 20 will be described with reference to FIGS. 10 to 12. FIG. 10 is a flowchart illustrating an example of the flow of the process of the symbol narrowing-down apparatus 20. FIGS. 11 and 12 are schematic diagrams illustrating an example of a control flow graph of a certain program for describing the symbol narrowing-down process by the symbol narrowing-down apparatus 20. Note that FIG. 11 illustrates a state before narrowing down the symbols, and FIG. 12 illustrates a state after narrowing down the symbols.

As illustrated in FIG. 10, first, the first code block extraction unit 22 performs static analysis or the like on the target binary to create the control flow graph (Step S201).

Thereafter, the symbol extraction unit 21 extracts the plurality of predetermined symbols (set S) determined based on the attribute information of at least one of the symbol type and the scope level of the symbol from all the symbols included in the target binary (Step S202). In the example of FIG. 11, symbols S1 to S6 are extracted as predetermined symbols (that is, the symbols S1 to S6 are extracted as elements of the set S).

Thereafter, the first code block extraction unit 22 extracts all of the plurality of code blocks having the specific property from the codes included in the target binary as the first code blocks (set D) to be analyzed as to whether the code blocks are the backdoors based on information such as the created control flow graph (Step S203). In the example of FIG. 11, eight dead code blocks D1 to D8 which are nodes having no parent node on the control flow graph are extracted as first code blocks D1 to D8 to be scored (that is, the first code blocks D1 to D8 are extracted as elements of the set D).

Thereafter, the second code block extraction unit 23 extracts all code blocks that perform a predetermined sensitive operation from the codes included in the target binary. Here, the second code block extraction unit 23 particularly extracts the plurality of code blocks that accesses the plurality of respective predetermined symbols (set S) extracted by the symbol extraction unit 21 as the plurality of second code blocks (set E) (Step S204). In the example of FIG. 11, six code blocks E1 to E6, which are nodes that access at least one of the symbols S1 to S6, are extracted as second code blocks E1 to E6 (that is, the second code blocks E1 to E6 are extracted as elements of the set E.).

At this time, the second code block (set Ea) traced from the normal control flow (for example, the main function in the case of C language) and the second code block (set Eb) which is the first code block or the child node thereof are specified from the plurality of second code blocks (set E) (Step S205). The identification of the sets Ea and Eb may be performed by the symbol narrowing-down unit 24 or may be performed by the second code block extraction unit 23.

Thereafter, the symbol narrowing-down unit 24 narrows down the symbols (Steps S206 to S210). A specific flow of the process by the symbol narrowing-down unit 24 is as follows. Here, as an example, a flow of a process in a case of detecting the backdoor code of the type in which the sensitive information inside the program is illegally taken out to the outside will be described.

First, one symbol that has not been selected as an inspection target is selected from the plurality of predetermined symbols (set S) extracted by the symbol extraction unit 21 (Step S206). Thereafter, one or more second code blocks accessing a symbol being selected are specified from the plurality of second code blocks (set E) extracted by the second code block extraction unit 23 (Step S207).

Thereafter, it is determined whether any one of the one or more second code blocks accessing the symbol being selected includes an element of the set Ea, and whether any one of the one or more second code blocks accessing the symbol being selected includes an element of the set Eb (Step S208). That is, it is determined whether any one of the one or more second code blocks accessing the symbol being selected includes the second code block traced from the normal control flow, and whether any one of the one or more second code blocks accessing the symbol being selected includes the second code block that is the first code block or a child node thereof.

For example, in a case where any one of the one or more second code blocks accessing the symbol being selected includes the element of the set Ea and any one of the one or more second code blocks accessing the symbol being selected includes the element of the set Eb (YES in Step S208), the symbol being selected is extracted as a symbol to be used for score calculation (Step S209). Otherwise (NO in Step S208), the symbol being selected is not extracted as a symbol to be used for score calculation.

Thereafter, in a case where an unselected symbol remains as the inspection target (YES in Step S210), an unselected symbol is selected as the inspection target (Step S206), and the processes of Steps S207 to S209 are performed. In a case where there remain no unselected symbols as inspection targets (NO in Step S210), the symbol narrowed-down for use in score calculation is output from the symbol output unit 25 (Step S211).

In the examples of FIGS. 11 and 12, through the process illustrated in FIG. 10, among the symbols S1 to S6, only the symbols S3 and S4 accessed from both the second code block traced from the normal control flow and the second code block that is the first code block or the child node thereof are narrowed-down.

As described above, the symbol narrowing-down apparatus 20 according to the present example embodiment can extract (that is, it depends on what type of backdoor candidate is extracted) symbols corresponding to the type of backdoor to be analyzed from a large number of symbols included in the program to be analyzed. As a result, depending on the type of the backdoor to be analyzed, the symbol that hardly contributes to the increase or decrease of the backdoor score can be excluded from the target used for the calculation of the backdoor score.

### Application Example of Symbol Narrowing-down Apparatus 20

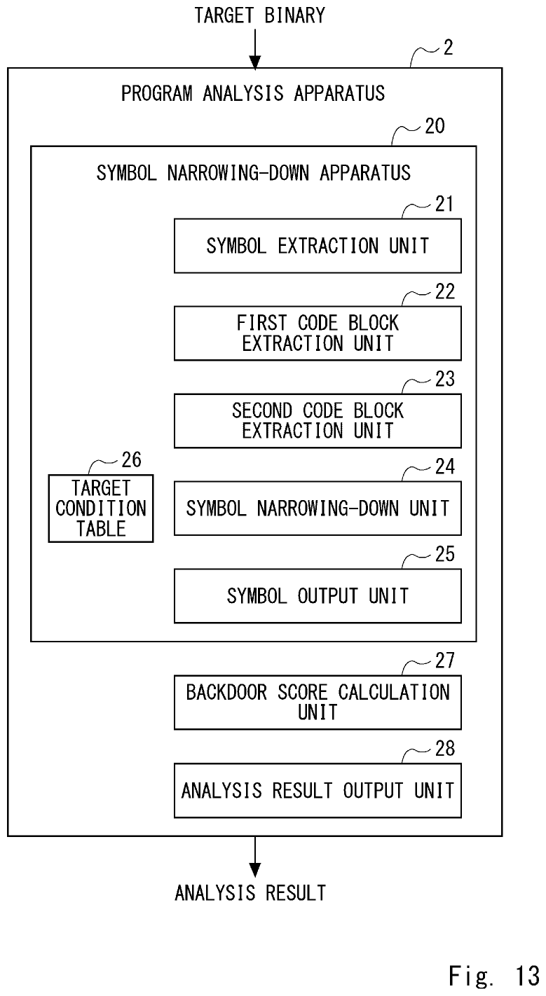

FIG. 13 is a block diagram illustrating a configuration example of the program analysis apparatus 2 on which the symbol narrowing-down apparatus 20 is mounted.

As illustrated in FIG. 13, the program analysis apparatus 2 includes a symbol narrowing-down apparatus 20, a backdoor score calculation unit 27, and an analysis result output unit 28.

The backdoor score calculation unit 27 calculates the backdoor score for each first code block extracted by the first code block extraction unit 22 based on the operation content of the code block that is the first code block or the child node of the first code block. Here, the backdoor score calculation unit 27 calculates the backdoor score at least based on the content of the symbol narrowed-down by the symbol narrowing-down apparatus 20, the symbol being accessed by the code block that is the first code block or the child node thereof.

The analysis result output unit 28 outputs the first code block extracted by the first code block extraction unit 22 and the backdoor score for the first code block calculated by the backdoor score calculation unit 27 as analysis results.

The output format of each first code block by the analysis result output unit 28 may be the symbol information in the target binary, a relative address of the code block, a code block name named at the time of analyzing the program, or the like. In addition, the first code block may be output in a mode in which the backdoor score for the code block is assigned.

Note that, in the symbol narrowing-down apparatus 20 and the program analysis apparatus 2 equipped with the same, it is assumed that a program to be analyzed is in a binary format and a binary of the program is input, but the source code may be used as the analysis target. In that case, the source code to be analyzed may be compiled and converted into a binary format in the symbol narrowing-down apparatus 20 or the program analysis apparatus 2. In addition, the symbol extraction unit 21, the first code block extraction unit 22, the second code block extraction unit 23, the symbol narrowing-down unit 24, the symbol output unit 25, the backdoor score calculation unit 27, or a processing unit (not illustrated) may appropriately use information obtained from the source code for analysis.

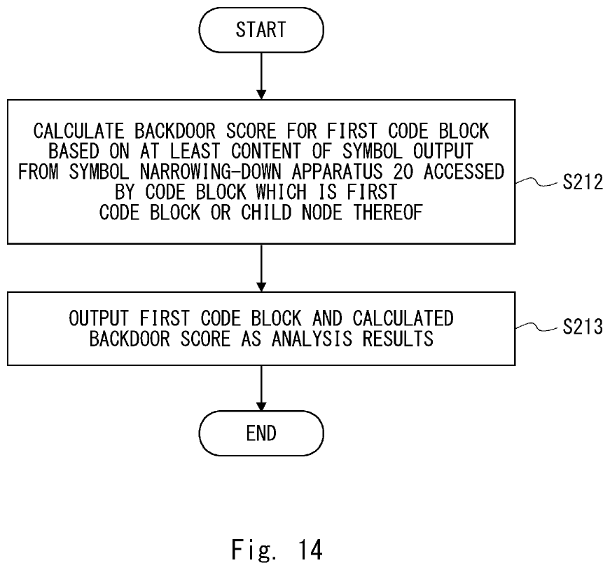

Next, an example of a flow of a process of the program analysis apparatus 2 will be described with reference to FIG. 14. FIG. 14 is a flowchart illustrating an example of the flow of the process of the program analysis apparatus 2. Note that, in FIG. 14, the symbol narrowing-down process by the symbol narrowing-down apparatus 20 is omitted.

As illustrated in FIG. 14, first, the backdoor score calculation unit 27 calculates the backdoor score for each first code block extracted by the first code block extraction unit 22 based on operation content (specifically, content of the predetermined sensitive operation) of the code block that is the first code block or the child node of the first code block. Here, the backdoor score calculation unit 27 calculates the backdoor score at least based on the content of the symbol narrowed-down by the symbol narrowing-down apparatus 20 which is accessed by the code block which is the first code block or the child node thereof (Step S212). Thereafter, the analysis result output unit 28 outputs the first code block extracted by the first code block extraction unit 22 and the backdoor score for the first code block calculated by the backdoor score calculation unit 27 as analysis results (Step S213).

As described above, the program analysis apparatus 2 according to the present example embodiment can present the first code block that is a candidate for the backdoor code included in the program to be analyzed and the backdoor score for the first code block, for example, to the analyst of the program. As a result, the analyst of the program can extract a candidate for the backdoor code from the program without comparing the code of the program to be analyzed with the specification or manually checking the code of the program.

Furthermore, the program analysis apparatus 2 according to the present example embodiment can calculate the backdoor score by excluding symbols that hardly contribute to the increase or decrease of the backdoor score depending on the type of the backdoor to be analyzed by using the symbol narrowing-down apparatus 20.

### Third Example Embodiment

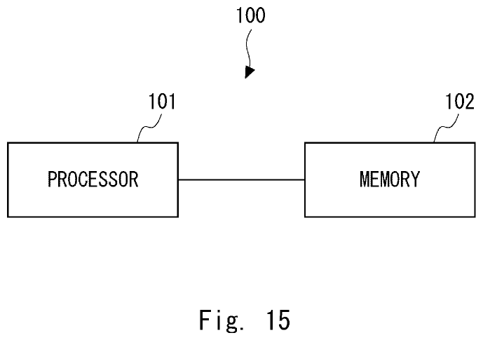

FIG. 15 is a diagram illustrating a hardware configuration example of a symbol narrowing-down apparatus 100 according to a third example embodiment. In FIG. 15, the symbol narrowing-down apparatus 100 includes a processor 101 and a memory 102. The processor 101 may be, for example, a microprocessor, a micro processing unit (MPU), or a central processing unit (CPU). The processor 101 may include a plurality of processors. The memory 102 is configured by a combination of a volatile memory and a nonvolatile memory. The memory 102 may include a storage located away from the processor 101. In this case, the processor 101 may access the memory 102 through an input/output (I/O) interface (not illustrated).

The symbol narrowing-down apparatus 10 according to the first example embodiment can have the hardware configuration illustrated in FIG. 15. In addition, the symbol extraction unit 11, the first code block extraction unit 12, the second code block extraction unit 13, the symbol narrowing-down unit 14, and the symbol output unit 15 in the symbol narrowing-down apparatus 10 may be realized by the processor 101 reading and executing a program stored in the memory 102.

Similarly, the symbol narrowing-down apparatus 20 according to the second example embodiment can have the hardware configuration illustrated in FIG. 15. In addition, the symbol extraction unit 21, the first code block extraction unit 22, the second code block extraction unit 23, the symbol narrowing-down unit 24, and the symbol output unit 25 in the symbol narrowing-down apparatus 20 may be realized by the processor 101 reading and executing a program stored in the memory 102. In addition, the target condition table 26 in the symbol narrowing-down apparatus 20 may be stored in the memory 102.

In FIG. 15, the hardware configuration example of the symbol narrowing-down apparatus 100 has been described, but the present invention is not limited thereto. The hardware configuration of the symbol narrowing-down apparatus equipped with the symbol narrowing-down apparatus 100 can also adopt a configuration including the processor 101 and the memory 102 as in the case of the symbol narrowing-down apparatus 100. Each of the program analysis apparatuses 1 and 2 can have a hardware configuration including the processor 101 and the memory 102.

The above-described programs for implementing the symbol narrowing-down apparatuses 10 and 20 and the program analysis apparatuses 1 and 2 can be stored using various types of non-transitory computer readable media and supplied to a computer. Examples of the non-transitory computer readable medium include a magnetic recording medium (for example, a flexible disk, a magnetic tape, or a hard disk drive), a magneto-optical recording medium (for example, a magneto-optical disk), a compact disc-read only memory (CD-ROM), a CD-recordable (CD-R), a CD-rewritable (CD-R/W), a semiconductor memory (for example, a mask ROM, a programmable ROM (PROM), an erasable PROM (EPROM), a flash ROM, and a random access memory (RAM)). Furthermore, the above-described program may be supplied to the computer by various types of transitory computer readable media. Examples of transitory computer-readable media include electrical signals, optical signals, and electromagnetic waves. The temporary computer readable medium can supply the program to the symbol narrowing-down apparatuses 10 and 20 and the program analysis apparatuses 1 and 2 via a wired communication path such as an electric wire and an optical fiber or a wireless communication path.

Although the present disclosure has been described with reference to the example embodiments, the present disclosure is not limited to the example embodiments described above. Various modifications that can be understood by those skilled in the art can be made to the configuration and details of the present disclosure within the scope of the present disclosure.

Some or all of the above example embodiments may be described as the following supplementary notes, but are not limited to the following.

(Supplementary Note 1)

A symbol narrowing-down apparatus including:
a symbol extraction means for extracting a plurality of predetermined symbols from codes included in a binary of a program;
a first code block extraction means for extracting a code block having a specific property from the codes included in the binary of the program as a first code block to be analyzed as to whether the code block is a backdoor;
a second code block extraction means for extracting, as a plurality of second code blocks, a plurality of code blocks that access the plurality of respective predetermined symbols from the codes included in the binary of the program;
a symbol narrowing-down means for extracting, from the plurality of predetermined symbols, a symbol to be accessed by the second code block satisfying a condition on a control flow according to a type of the backdoor to be analyzed among the plurality of second code blocks; and
a symbol output means for outputting the symbol extracted by the symbol narrowing-down means.

(Supplementary Note 2)

The symbol narrowing-down apparatus according to Supplementary Note 1, wherein the symbol extraction means extracts a plurality of symbols determined based on attribute information of at least one of a symbol type and a scope level as the plurality of predetermined symbols.

(Supplementary Note 3)

The symbol narrowing-down apparatus according to Supplementary Note 1 or 2, wherein the symbol narrowing-down means extracts a symbol accessed from both a second code block that is the first code block or a child node of the first code block and a second code block that is any one of a plurality of code blocks constituting a normal control flow among the plurality of second code blocks, from the plurality of predetermined symbols extracted by the symbol extraction means.

(Supplementary Note 4)

The symbol narrowing-down apparatus according to Supplementary Note 1 or 2, wherein the symbol narrowing-down means extracts a symbol, which is accessed by the second code block which is the first code block or a child node of the first code block and accesses an external resource among the plurality of second code blocks, from the plurality of predetermined symbols extracted by the symbol extraction means.

(Supplementary Note 5)

The symbol narrowing-down apparatus according to any one of Supplementary Notes 1 to 4, wherein the first code block extraction means extracts a code block which cannot be reached by a normal control flow from codes included in the binary as the first code block which is a code block having the specific property when the program is executed.

(Supplementary Note 6)

The symbol narrowing-down apparatus according to any one of Supplementary Notes 1 to 4, wherein the first code block extraction means extracts a code block which does not pass through a code block having a predetermined function which is passed through a normal control flow from codes included in the binary as the first code block which is a code block having the specific property when the program is executed.

(Supplementary Note 7)

A program analysis apparatus comprising:
the symbol narrowing-down apparatus according to any one of Supplementary Notes 1 to 6;
a backdoor score calculation means for calculating a backdoor score that is a score indicating a possibility that the first code block is a backdoor code or a score indicating a magnitude of an influence on a system when the first code block is executed based on at least content of the symbol output from the symbol narrowing-down apparatus, the symbol being accessed by a code block that is the first code block or a child node of the first code block; and
an analysis result output means for outputting the first code block and the backdoor score for the first code block as an analysis result.

(Supplementary Note 8)

A symbol extraction method executed by a symbol narrowing-down apparatus, the symbol extraction method comprising:
a symbol extraction step of extracting a plurality of predetermined symbols from codes included in a binary of a program;
a first code block extraction step of extracting a code block having a specific property from the codes included in the binary of the program as a first code block to be analyzed as to whether the code block is a backdoor;
a second code block extraction step of extracting a plurality of second code blocks that access the plurality of respective predetermined symbols from the codes included in the binary of the program;
a symbol narrowing-down step of extracting, from the plurality of predetermined symbols, a symbol to be accessed by the second code block satisfying a condition on a control flow according to a type of the backdoor to be analyzed among the plurality of second code blocks; and
a symbol output step of outputting the symbol extracted in the symbol narrowing-down step.

(Supplementary Note 9)

A program analysis method executed by a program analysis apparatus, the program analysis method comprising:
a backdoor score calculation step of calculating a backdoor score that is a score indicating a possibility that the first code block is a backdoor code or a score indicating a magnitude of an influence on a system when the first code block is executed based on at least content of the symbol output by the symbol extraction method according to Supplementary Note 8, the symbol being accessed by a code block that is the first code block or a child node of the first code block; and
an analysis result output step of outputting the first code block and the backdoor score for the first code block as an analysis result.

(Supplementary Note 10)

A non-transitory computer readable medium storing a program for causing a computer to execute:
a symbol extraction process of extracting a plurality of predetermined symbols from codes included in a binary of a program;
a first code block extraction process of extracting a code block having a specific property from the codes included in the binary of the program as a first code block to be analyzed as to whether the code block is a backdoor;
a second code block extraction process of extracting a plurality of second code blocks that access the plurality of respective predetermined symbols from the codes included in the binary of the program;
a symbol narrowing-down process of extracting, from the plurality of predetermined symbols, a symbol to be accessed by the second code block satisfying a condition on a control flow according to a type of the backdoor to be analyzed among the plurality of second code blocks; and
a symbol output process of outputting the symbol extracted in the symbol narrowing-down process.

(Supplementary Note 11)

The non-transitory computer readable medium storing a program according to Supplementary Note 10 that further causes a computer to execute:
a backdoor score calculation process of calculating a backdoor score that is a score indicating a possibility that the first code block is a backdoor code or a score indicating a magnitude of an influence on a system when the first code block is executed based on at least content of the symbol output by the symbol output process, the symbol being accessed by a code block that is the first code block or a child node of the first code block; and
an analysis result output process of outputting the first code block and the backdoor score for the first code block as an analysis result.

### REFERENCE SIGNS LIST

1 PROGRAM ANALYSIS APPARATUS
2 PROGRAM ANALYSIS APPARATUS
10 SYMBOL NARROWING-DOWN APPARATUS
11 SYMBOL EXTRACTION UNIT
12 FIRST CODE BLOCK EXTRACTION UNIT
13 SECOND CODE BLOCK EXTRACTION UNIT
14 SYMBOL NARROWING-DOWN UNIT
15 SYMBOL OUTPUT UNIT
17 BACKDOOR SCORE CALCULATION UNIT
18 ANALYSIS RESULT OUTPUT UNIT
20 SYMBOL NARROWING-DOWN APPARATUS
21 SYMBOL EXTRACTION UNIT
22 FIRST CODE BLOCK EXTRACTION UNIT
23 SECOND CODE BLOCK EXTRACTION UNIT
24 SYMBOL NARROWING-DOWN UNIT
25 SYMBOL OUTPUT UNIT
26 TARGET CONDITION TABLE
27 BACKDOOR SCORE CALCULATION UNIT
28 ANALYSIS RESULT OUTPUT UNIT
50 PROGRAM ANALYSIS APPARATUS
51 CODE BLOCK EXTRACTION UNIT
52 BACKDOOR SCORE CALCULATION UNIT
53 ANALYSIS RESULT OUTPUT UNIT
100 SYMBOL NARROWING-DOWN APPARATUS
101 PROCESSOR
102 MEMORY

What is claimed is:

1. A symbol narrowing-down apparatus comprising:
at least one memory storing program instructions; and
at least one processor coupled to the at least one memory, the at least one processor being configured to execute the program instructions stored in the at least one memory to:
extract a plurality of predetermined symbols from codes included in a binary of a program;
extract a code block having a specific property from the codes included in the binary of the program as a first code block to be analyzed as to whether the code block is a backdoor;
extract, as a plurality of second code blocks, a plurality of code blocks that access the plurality of respective predetermined symbols from the codes included in the binary of the program;
extract, from the plurality of predetermined symbols, a symbol to be accessed by the second code block satisfying a condition on a control flow according to a type of the backdoor to be analyzed among the plurality of second code blocks; and
output the symbol extracted in a narrowing-down of the symbols.

2. The symbol narrowing-down apparatus according to claim 1, wherein in the extraction of the plurality of predetermined symbols, a plurality of symbols determined based on attribute information of at least one of a symbol type and a scope level are extracted as the plurality of predetermined symbols.

3. The symbol narrowing-down apparatus according to claim 1, wherein in the narrowing-down of the symbols, a symbol accessed from both a second code block that is the first code block or a child node of the first code block and a second code block that is any one of a plurality of code blocks constituting a normal control flow among the plurality of second code blocks is extracted, from the plurality of predetermined symbols.

4. The symbol narrowing-down apparatus according to claim 1, wherein in the narrowing-down of the symbols, a symbol, which is accessed by the second code block which is the first code block or a child node of the first code block and accesses an external resource among the plurality of second code blocks, is extracted from the plurality of predetermined symbols.

5. The symbol narrowing-down apparatus according to claim 1, wherein in the extraction of the first code block, a code block which cannot be reached by a normal control flow is extracted from codes included in the binary as the first code block which is a code block having the specific property when the program is executed.

6. The symbol narrowing-down apparatus according to claim 1, wherein in the extraction of the first code block, a code block which does not pass through a code block having a predetermined function which is passed through a normal control flow is extracted from codes included in the binary as the first code block which is a code block having the specific property when the program is executed.

7. A program analysis apparatus comprising the symbol narrowing-down apparatus according to claim 1,
wherein the at least one processor is further configured to execute the program instructions stored in the at least one memory to:
calculate a backdoor score that is a score indicating a possibility that the first code block is a backdoor code or a score indicating a magnitude of an influence on a system when the first code block is executed based on at least content of the symbol output from the symbol narrowing-down apparatus, the symbol being accessed by a code block that is the first code block or a child node of the first code block; and
output the first code block and the backdoor score for the first code block as an analysis result.

8. A symbol extraction method executed by a symbol narrowing-down apparatus, the symbol extraction method comprising:
extracting a plurality of predetermined symbols from codes included in a binary of a program;
extracting a code block having a specific property from the codes included in the binary of the program as a first code block to be analyzed as to whether the code block is a backdoor;
extracting, as a plurality of second code blocks, a plurality of code blocks that access the plurality of respective predetermined symbols from the codes included in the binary of the program;
extracting, from the plurality of predetermined symbols, a symbol to be accessed by the second code block satisfying a condition on a control flow according to a type of the backdoor to be analyzed among the plurality of second code blocks; and
outputting the symbol extracted in a narrowing-down of the symbols.

9. A program analysis method executed by a program analysis apparatus, the program analysis method comprising:
calculating a backdoor score that is a score indicating a possibility that the first code block is a backdoor code or a score indicating a magnitude of an influence on a system when the first code block is executed based on at least content of the symbol output by the symbol extraction method according to claim 8, the symbol being accessed by a code block that is the first code block or a child node of the first code block; and
outputting the first code block and the backdoor score for the first code block as an analysis result.

10. A non-transitory computer readable medium storing a program for causing a computer to execute:
a symbol extraction process of extracting a plurality of predetermined symbols from codes included in a binary of a program;
a first code block extraction process of extracting a code block having a specific property from the codes included in the binary of the program as a first code block to be analyzed as to whether the code block is a backdoor;
a second code block extraction process of extracting, as a plurality of second code blocks, a plurality of code blocks that access the plurality of respective predetermined symbols from the codes included in the binary of the program;
a symbol narrowing-down process of extracting, from the plurality of predetermined symbols, a symbol to be accessed by the second code block satisfying a condition on a control flow according to a type of the backdoor to be analyzed among the plurality of second code blocks; and
a symbol output process of outputting the symbol extracted in the symbol narrowing-down process.

11. The non-transitory computer readable medium storing a program according to claim 10 that further causes a computer to execute:
a backdoor score calculation process of calculating a backdoor score that is a score indicating a possibility that the first code block is a backdoor code or a score indicating a magnitude of an influence on a system when the first code block is executed based on at least content of the symbol output by the symbol output process, the symbol being accessed by a code block that is the first code block or a child node of the first code block; and
an analysis result output process of outputting the first code block and the backdoor score for the first code block as an analysis result.
